(19) United States
(12) Patent Application Publication
(10) Pub. No.: US 2011/0102902 A1
(43) Pub. Date: May 5, 2011

(54) Security apparatus

(75) Inventor: Dana J. Butcher, Fresno, CA (US)

(73) Assignee: William D. Megeath

(21) Appl. No.: 12/590,286

(22) Filed: Nov. 5, 2009

(51) Int. Cl. G02B 23/16

(52) U.S. Cl. 359/610; 109/49.5

(57) ABSTRACT

A security apparatus for a work object, the security apparatus having an enclosure adapted to be mounted in proximity to the work object in at least partially obscuring relation thereto; and a portion mounted on the enclosure for imparting at least limited visual observation of the work object through the enclosure for operation of the work object.

### CROSS-REFERENCE TO RELATED APPLICATIONS

Not applicable.

### STATEMENT REGARDING FEDERALLY SPONSORED RESEARCH OR DEVELOPMENT

Not Applicable.

### BACKGROUND OF THE INVENTION

(1) Field Of The Invention

The present invention relates to a security apparatus and, more particularly, to a security apparatus which is operated in cooperation with security systems and the like substantially to improve the security of the environment in which the security apparatus is employed.

(2) Description Of The Prior Art

The extent to which security systems are employed in a multitude of environments has proliferated over the years for numerous reasons. Among these reasons are, of course, the prevalence of crime and activities which require limited access as well as the rapid development of technologies adapted to provide security.

For example, many of these new technologies are predicated upon the use of an entry code which is used by authorized personnel. There may be a single code, or different codes which are used by different authorized personnel, or different codes for access to different areas. In any case, the designated code is typically used by employing an electronic key pad in which the code is entered to cause a door, or the like, to be enabled to be opened. The key pad contains a plurality of buttons or keys bearing numbers, and/or letters, and/or symbols. The pressing of the correct code into the pad using the keys allows entry through the door by releasing a locking mechanism borne by the door. Such systems are commonly used, for example, in military installations, airline terminals, safes, ATM machines, commercial buildings, hotels, homes, government buildings and a wide variety of other facilities.

While such security systems constitute an advance over prior art systems, they have their own flaws or weaknesses. While one might think that no one could read the code from a distance as it is entered by authorized personnel, this is clearly not the case. In crowded airline terminals, for example, it is readily possible to get close enough to the person punching in the code to determine what the code is. The person may attempt to shield the pad from view, but this is inadequate to accomplish this purpose. The authorized person may even be observed from a considerable distance using binoculars, or other vision enhancing equipment.

There are a plurality of other types of devices and systems which present the same, or similar, hazards or weaknesses. While no purpose would be served by enumerating all such environments, it is sufficient to state that security requires that such codes, or other sensitive information be maintained in secret. Without the assurance of such protection, an entire facility may be compromised and thus rendered vulnerable to access by unauthorized personnel.

Therefore, it has long been known that it would be desirable to have a security apparatus which interoperates with existing security devices to maximize the effectiveness thereof; which is dependably effective even under the most adverse conditions; which is inexpensive to manufacture and sell; which is of simplified construction; which can readily be installed; which is intuitively operated so as to require little or no training for use thereof; and which is otherwise fully effective in accomplishing its intended purposes.

### BRIEF SUMMARY OF THE INVENTION

Therefore, it is an object of the present invention to provide an improved security apparatus which is capable of dependably solving security problems which have plagued otherwise secure locations.

Another object is to provide such a security apparatus which can be installed and used to augment conventional security devices.

Another object is to provide such a security apparatus which is so constructed as to be largely intuitive to operate.

Another object is to provide such a security apparatus which is operable to facilitate the use of security devices by assisting in the maintenance of security during the use of general security devices.

Another object is to provide such a security apparatus which is quite inexpensive to construct, install and use.

Another object is to provide such a security apparatus which has particular utility in obstructing the view while confidential information is being used so as not to permit that information to be transferred to unauthorized personnel.

Another object is to provide such a security apparatus which has particular utility in maintaining security at such objectively secure locations as military installations, airports, train stations, banks, virtually all types of businesses, secure areas within structures of all types, and the like.

Another object is to provide such a security apparatus which is substantially automatically operable to control the line of sight in the use of various conventional security devices.

Another object is to provide such a security apparatus which is unusually well suited to use in conjunction with other electronic security devices including electronic key pads used in controlling entry to secure areas.

Further objects and advantages are to provide improved elements and arrangements thereof in an apparatus for the purpose described which is dependable, economical, durable and fully effective in accomplishing its intended purposes.

These and other objects and advantages are achieved, in the preferred embodiment of the present invention, in a security apparatus for a work object having an enclosure adapted to be mounted in proximity to the work object in at least partially obscuring relation thereto; and walls borne by the enclosure for imparting at least limited visual observation of the work object through the enclosure.

### BRIEF DESCRIPTION OF THE SEVERAL VIEWS OF THE DRAWINGS

FIG. 1 is a fragmentary perspective view of the security apparatus of the present invention showing the security apparatus enclosing an electronic key pad, which is shown in phantom lines, in a typical operative environment.

FIG. 2 is a fragmentary front elevational perspective view of the security apparatus of FIG. 1.

FIG. 3 is an exploded, fragmentary perspective view of the security apparatus of FIG. 1.

FIG. 4 is a somewhat enlarged, front elevation of the security apparatus of FIG. 1.

FIG. 5 is a transverse vertical section of the security apparatus taken on line 5-5 in FIG. 4.

FIG. 6 is a fragmentary lower perspective view of the security apparatus of the present invention shown in the typical operative environment.

### DETAILED DESCRIPTION OF THE INVENTION

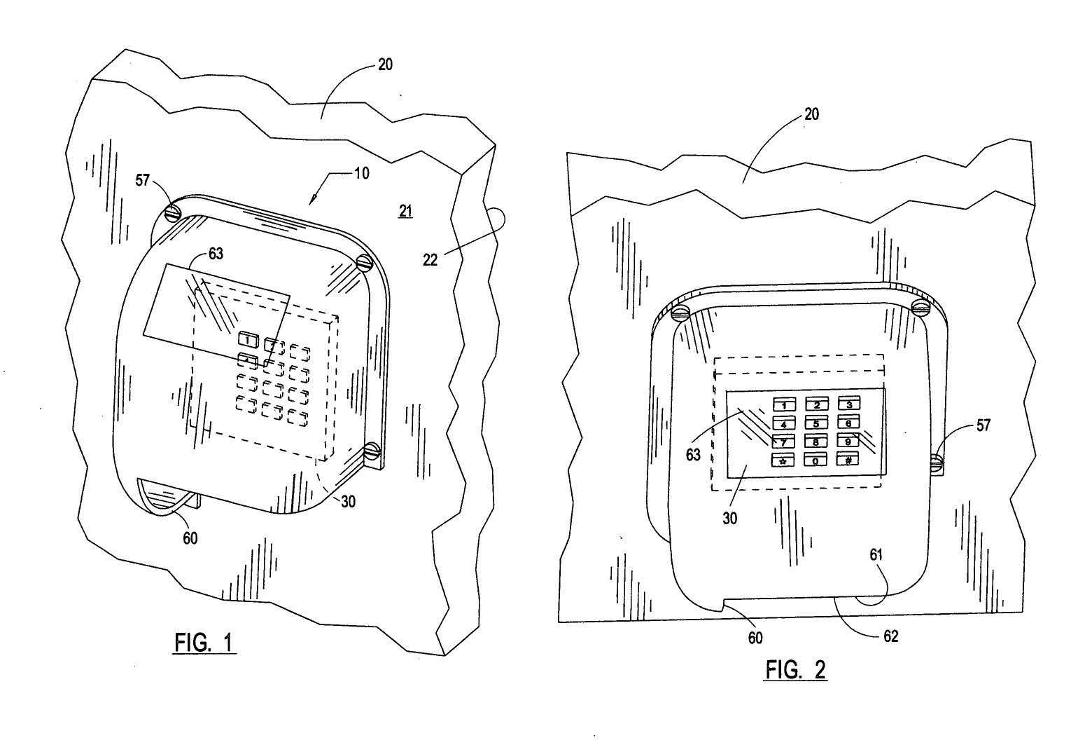

Referring more particularly to the drawings, the apparatus of the present invention in generally indicated by the numeral 10 in FIG. 1.

As shown therein, the security apparatus is shown in a typical operative environment mounted on a wall 20 having a front surface 21 and an opposite rear surface 22. A security key pad or security device pad 30 is operably mounted on the front surface 21 of the wall. It will be understood that the security pad can alternatively be mounted directly on a door, door jamb, or the like for operation to gain access rather than on a wall adjacent to the door, or for any other appropriate usage. This is solely a matter of particular type of security device used and may be controlled by a variety of factors. It does not, however, affect the effectiveness of the security pad, or the applicability of the security apparatus of the present invention, or in any other way affect its usage.

In the illustrative example, the security pad 30, or that portion which is visible in the several views, has a rectangular metal housing 31 having a substantially flat front surface 32. It will be understood that the rectangular metal housing is made of a hardened metal, such as steel, and is so mounted in placed as to prevent removal from the front surface 21 of the door 20.

The security pad 30 houses and similarly protects the internal electro-mechanical components thereof. A plurality of rectangular openings 33 extend through the front surface 21. In the illustrative example hereof there are a total of twelve (12) such rectangular openings arranged in three (3) rows. A button or key 34 is slidably received in each such opening extending outwardly therethrough. Each of the keys has a numeral or other symbol thereon and is depressed with the finger of the operator in the process of entering on the key pad the particular code which will release the door 20 or the like to be opened. The particular code required to be entered is typically composed of numbers entered in a prescribed order followed, for example, by the star (*) symbol. Without entry of the correct code in the correct sequence, the door cannot be opened because the internal lock is not released.

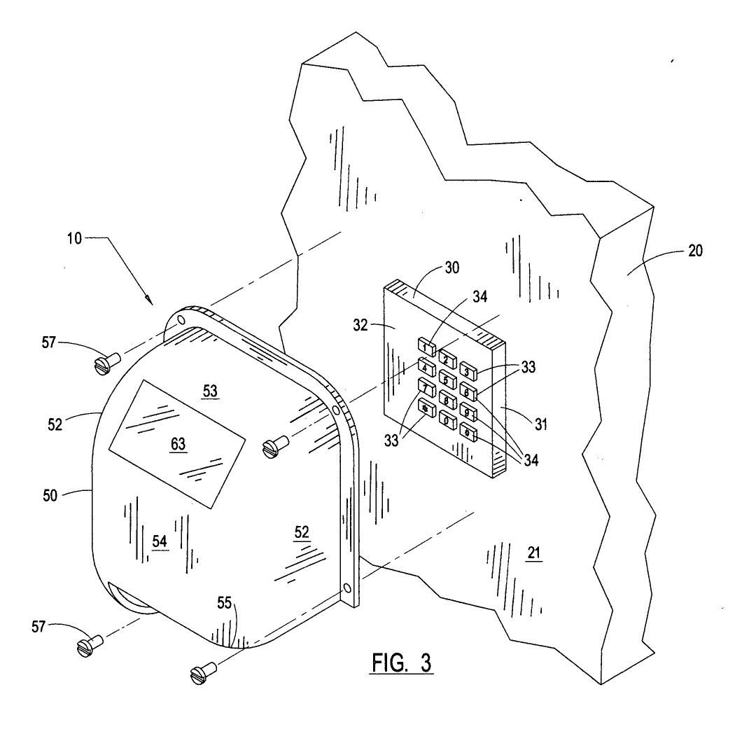

The security apparatus 10 of the present invention has a housing 50 perhaps best shown in FIG. 3. The housing can be made of any suitable material and shape as will hereinafter be described. The housing can, for example, be made of a molded plastic or metal material as desired.

Except as hereinafter setforth, the housing is opaque or completely nontransparent. Preferably the housing is opaque so that ambient light is admitted, but it is sufficiently opaque that nothing within the housing is discernable.

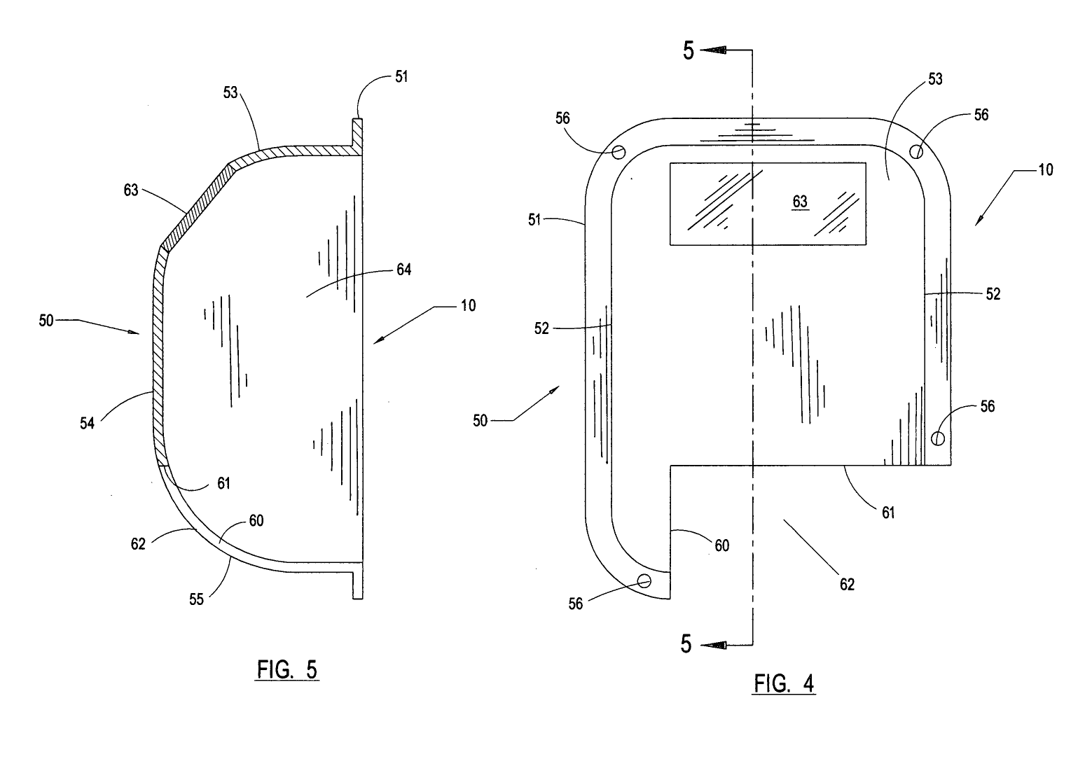

The housing is bounded by a lip 51 which defines a substantially flat plane, as best shown in FIGS. 4 and 5. The housing has substantially parallel opposite sidewalls 52.

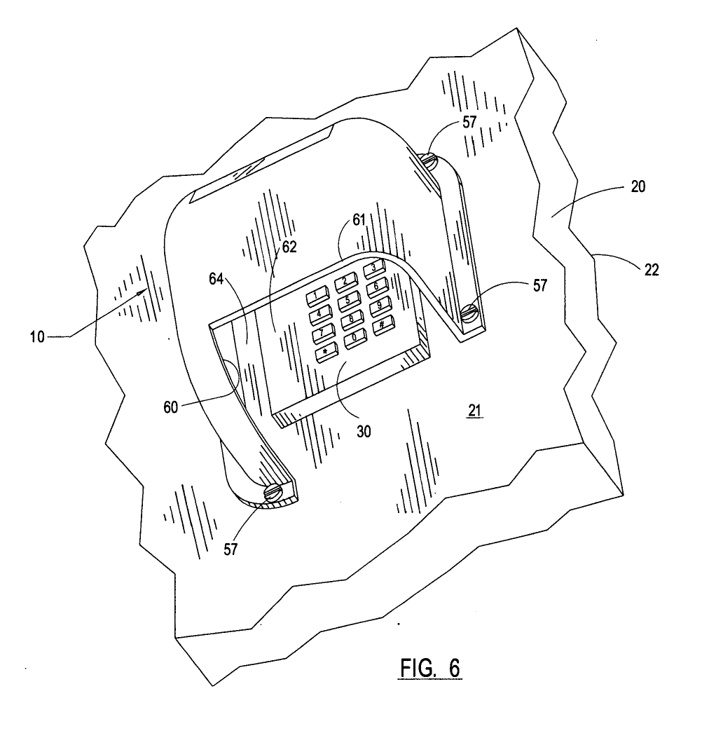

The transparent rectangular window 63 can be of any desired shape or other configuration. In the preferred embodiment the window has a rectangular configuration when viewed face on or in front elevation. In the preferred embodiment the window has a transversely curved configuration, as perhaps best shown in FIG. 5, but may, for example, be transversely flat, or any other suitable configuration. The window can provide magnification, if desired, to aid the authorized person in pressing the keys 34. However, for purposes of security, this may not be desired. The security apparatus 10 in its installed condition bounds an interior 64, as will hereinafter be discussed in greater detail. As perhaps most clearly shown in FIG. 6, the access opening 62 is slightly off set to the right for the convenience of the more common right handed people. However, the access opening extends to the left sufficiently to permit ease of access by left handed people.

### OPERATION

The operation of the described embodiment of the subject invention is believed to be clearly apparent and it briefly summarized at this point.

The security apparatus 10 is installed as best illustrated in FIG. 3. The screws 57 are individually extended through the screw holes 56 and screwthreadably extended into the door 20 to mount the security apparatus in covering relation to the security pad 30. The security apparatus may alternatively be adhesively mounted in place, or mounted by other suitable means. The security apparatus is thus mounted on the front surface 21 of the door in the position best shown in FIGS. 1 and 2. In this installed position, the window 63 is in position to provide a clear view to the authorized person standing in front thereof of all of the keys 34, as best shown in FIG. 2. This view shown in FIG. 2 is roughly the view visible to authorized personnel. The interior 64 of the security apparatus thus encloses the security pad therewithin.

By extending the operator's hand upwardly into the access opening 62, the operator presses the keys 34 to enter the proper code. It will be seen that persons standing in the vicinity, with or without the aid of binoculars, or the like, cannot see and therefore cannot discern the authorized code so entered. Since all of the security apparatus except the window 63 is opaque or completely obscured, no vision of the keys by other than the authorized operator is possible.

As previously noted, in the preferred embodiment, the security apparatus with the exception of the window is opaque allowing ambient light into the interior 64, while completely obstructing the view of unauthorized personnel

Therefore, the security apparatus of the present invention is particularly well suited to operation with existing security devices; interoperates with all security devices to maximize the effectiveness thereof; is dependably effective in the most adverse of conditions; is inexpensive to manufacture and sell; is of simplified construction; can readily be installed; is intuitively operated so as to require little or no training for use thereof; and is otherwise fully effective in accomplishing its intended purpose.

Although the invention has been herein shown and described in what is conceived to be the most practical and preferred embodiment, it is recognized that departures may be made therefrom within the scope of the invention which is not to be limited to the illustrative details disclosed.

Having described my invention, what I claim as new and desire to secure by Letters Patent is:

1. A security apparatus for a work object, the security apparatus comprising an enclosure adapted to be mounted in proximity to the work object in at least partially obscuring relation thereto; and means borne by the enclosure for imparting at least limited visual observation of the work object through the enclosure.

2. The security apparatus of claim 1 wherein said work object has a target area and said imparting means provides at least limited visual acuity of the target area of the work object.

3. The security apparatus of claim 1 wherein said enclosure has at least a portion thereof which is opaque operable to permit light to at least partially pass therethrough onto said work object.

4. The security apparatus of claim 1 wherein said enclosure is partially opaque and partially transparent.

5. The security apparatus of claim 4 wherein said work object is part of an entry system wherein a portion of the work object has code entry contact points, said transparent portion of the enclosure substantially overlays said entry code contact points and said partially opaque portion substantially encloses the remainder of said entry system.

6. The security apparatus of claim 5 wherein said enclosure is mounted for movement to provide at least partial access of the hand of an operator to operate said contact points.

7. The security apparatus of claim 5 wherein said enclosure has sidewalls bounding an opening of sufficient size to permit access by a hand of an operator for operation of said entry code contact points so as to permit operation of the entry system.

8. A security apparatus for substantially preventing operation of an entry system having a code entry pad assembly or the like disposed to have and entry code designated thereon for operation of the entry system, the security apparatus comprising a housing having opaque walls bounding an internal compartment, said walls being sufficiently magnified opaque to obscure vision therethrough and sufficiently transparent to permit ambient light to pass therethrough to illuminate said internal compartment and said housing having a transparent portion to permit the operator to see the entry pad assembly for operation thereof and an opening to permit the hand of an operator to be extended through said opening of the housing into said internal compartment for operation of the code entry pad assembly; and means mounting said housing in covering relation to said pad assembly whereby said operator can enter said code on the entry pad assembly substantially without observation.

9. The security apparatus of claim 8 wherein said transparent portion is disposed to provide a line of sight from said operator, through the transparent portion of the housing to the entry pad assembly.

10. The security apparatus of claim 9 wherein said transparent portion contains a magnifying lens for magnifying the entry pad assembly along said line of sight for improved vision by the operator.

11. The security apparatus of claim 10 wherein said magnifying lens is disposed at a substantially right angle to said line of sight.
